(19) United States
(12) Patent Application Publication
(10) Pub. No.: US 2011/0229404 A1
(43) Pub. Date: Sep. 22, 2011

(54) PROCESS FOR PRODUCING HYDROGEN

(76) Inventors: Chang Jie GUO, Houston, TX (US); Mahesh Venkataraman Iyer, Houston, TX (US)

(21) Appl. No.: 13/049,274

(22) Filed: Mar. 16, 2011

Related U.S. Application Data
(60) Provisional application No. 61/314,218, filed on Mar. 16, 2010.

(51) Int. Cl. C01B 3/22

(52) U.S. Cl. 423/648.1

(57) ABSTRACT

A process is described for producing hydrogen comprising producing an aqueous feed stream comprising 5% to 15% wt. ethanol by a biomass fermentation process; separating at least a portion of the water from the feed stream so that the concentration of ethanol in the resulting reformer feed stream is in the range of from 15% to 35% wt.; and contacting the reformer feed stream with a catalyst in a reformer under reforming conditions to produce a reformer product stream comprising hydrogen wherein the pressure in the reformer is in a range of from 100 psi to 600 psi.

This application claims priority to U.S. Provisional Application No. 61/314,218, filed on Mar. 16, 2010, which is herein incorporated by reference.

### FIELD OF INVENTION

This invention relates to an improved process for producing hydrogen.

### BACKGROUND

Hydrogen will play an important role in meeting the world's future sustainable energy needs. However, many conventional hydrogen production processes are disfavored because they emit significant amounts of carbon dioxide due to the use of fossil fuel feedstocks.

It is desirable to develop a process for producing hydrogen that uses renewable feedstocks and less energy. In addition, it would be beneficial if such a process had a smaller carbon footprint than conventional hydrogen production processes.

U.S. Pat. No. 6,387,554 to Verykios describes a process for the production of hydrogen and electrical energy, with zero emissions of pollutants, from ethanol which is produced from biomass, The process is characterized by the partial oxidation/reforming of ethanol with water for hydrogen production which is subsequently fed to a fuel cell for production of electrical energy.

### SUMMARY

This invention provides a process for producing hydrogen comprising: (a) producing an aqueous feed stream comprising 5% to 15% wt. ethanol by a biomass fermentation process; (b) separating at least a portion of the water from the feed stream so that the concentration of ethanol in the resulting reformer feed stream is in the range of from 15% to 35% wt; and contacting the reformer feed stream with a catalyst in a reformer under reforming conditions to produce a reformer product stream comprising hydrogen wherein the pressure in the reformer is in a range of from 100 psi to 600 psi.

### BRIEF DESCRIPTION OF DRAWINGS

FIG. 1 is a process flow diagram of an embodiment of the invention.

FIG. 2 is a process flow diagram of a typical fuel ethanol production process followed by an ethanol steam reforming process.

FIG. 3 is a process flow diagram of a conventional low pressure ethanol reforming process.

### DETAILED DESCRIPTION

The invention provides a process for producing hydrogen from a feed stream containing ethanol and water by contact with a reforming catalyst under high pressure reforming conditions. This process produces high pressure hydrogen without the need for a gaseous compressor since the feedstock to the reformer is pumped as a liquid and subsequent steps after the reformer are carried out in the vapor phase under high pressure conditions.

The feed stream of ethanol and water is produced by a biomass fermentation process which includes any process known to those skilled in the art or developed in the future which comprises fermentation of a biomass and/or the sugars extracted from the biomass to produce an aqueous ethanol-containing liquid.

In one embodiment, the biomass fermentation process uses corn as a starting feed which passes through a series of steps including milling, cooking/liquefaction, saccharification, fermentation and solids removal to produce an aqueous ethanol-containing liquid. Alternatively, sugar cane, syrup, beet juice, molasses, cellulose, sorbitol, algae, glucose, or acetates, such as ethyl acetate or methyl acetate may be fed to the biomass fermentation process. One of ordinary skill in the art will be able to operate the fermentation process according to known methods. In another embodiment, a second generation biomass feed such as lignocellulosic biomass, for example corn stover, straw, and wood chips, can be used as a feed to the fermentation process. One of ordinary skill in the art will be able to modify this process for any other biomass feed that can be used to produce ethanol.

The feed stream produced by the biomass fermentation process may comprise solids or other byproducts that are removed. The resulting feed stream contains from 5% to 15% wt. of ethanol, preferably from 8% to 12% wt. of ethanol.

The feed stream is pumped to a distillation column, or flash drums or other suitable separation apparatus to remove a portion of the water from the stream. This separation is preferably performed in a simple distillation column with 2-10 stages or in a sequence of flash drums. This separation can be carried out by any known method. The column is designed to produce a reformer feed stream with an ethanol content of from 15% to 35% wt, preferably from 20% to 30% wt. Optional additional heating may be provided to the reformer feed stream before feeding it to the reformer.

This separation is different from the conventional separation that is typically applied to the product of the fermentation process, because in conventional processes, a high purity ethanol stream is desired to meet fuel grade and/or chemical grade specifications. The high purity ethanol stream has an ethanol content of greater than 99% wt. The conventional separation is a very energy intensive process because ethanol and water form an azeotrope under these separation conditions. Generally, additional treatment steps such as zeolite adsorbent based VSA (vacuum swing adsorption) are required in addition to the intensive distillation operation. The cost of treatment significantly adds to the production cost of the 99% pure ethanol. For example, the conventional treatment processes may result in over 50 percent of the actual utility cost in producing ethanol from fermentation based processes.

The separation of this process is a simple distillation or flash step that does not require such a high purity so the azeotropic conditions are not reached and the separation process does not require as much energy.

Another difference from the conventional separation is that the feed stream is pumped to a pressure of from 100 psi to 600 psi before being fed to the distillation column. The conventional separation is not carried out at a high pressure because the higher pressure results in a more difficult separation that requires more energy.

The reformer feed stream exiting the separation apparatus in the vapor phase is fed to the reformer after preheating to produce a reformate comprising primarily hydrogen, carbon dioxide and carbon monoxide and some methane. For hydrogen production purpose, the reformate is preferably a hydrogen rich stream containing more than 50 mol % hydrogen on a dry basis which is further reacted in a water gas shift reaction to convert most of the carbon monoxide into hydrogen and CO₂. The final water gas shift effluent stream contains at least 60 mol % hydrogen on a dry basis.

The reformer feed stream typically has a steam to carbon ratio in the range of from 2 to 4, preferably from 2.5-3.5.

A hydrocarbon stream may also be fed to the reformer with the reformer feed stream described above. The addition of hydrocarbon affects the steam to carbon ratio in the reformer. If additional hydrocarbon is added, then additional steam can be present while maintaining the desired steam to carbon ratio. This allows the operation of the reformer to be optimized in relation to the degree of separation of water from the feed stream. The separation step may be operated to remove less water if a hydrocarbon stream is being added to the reformer.

The hydrocarbon stream comprises a hydrocarbon or mixture thereof with from 1 to 30 carbon atoms, preferably with from 1 to 15 carbon atoms and more preferably with from 1 to 4 carbon atoms. The hydrocarbon stream preferably comprises methane. The hydrocarbon stream can be produced at least partially during the biomass fermentation process. The hydrocarbon stream may comprise natural gas that is produced elsewhere.

As described above, the reformer feed stream generally contacts a catalyst within the reformer to accelerate the conversion of ethanol to hydrogen. The catalyst may include those catalysts capable of operating at equilibrium under steam reforming operation conditions. For example, the catalyst may include those catalysts capable of operating at equilibrium under reformer operation temperatures of less than 900° C.

The catalyst generally includes a support material and a metal component, which are described in greater detail below. The “support material” as used herein refers to the support material prior to contact with the metal component and an optional “modifier”, also discussed in further detail below.

The support material may include transition metal oxides or other refractory substrates, for example. The transition metal oxides may include alumina (including gamma, alpha, delta or eta phases), silica, zirconia or combinations thereof, such as amorphous silica-alumina. In one specific embodiment, the transition metal oxide includes alumina. In another specific embodiment, the transition metal oxide includes gamma alumina.

The support material may have a surface area of from 30 m²/g to 500 m²/g, or from 40 m²/g to 400 m²/g or from 50 m²/g to 350 m²/g. As used herein, the term “surface area” refers to the surface area as determined by the nitrogen BET (Brunauer, Emmett and Teller) method as described in Journal of the American Chemical Society 60 (1938) pp. 309-316. As used herein, surface area is defined relative to the weight of the support material, unless stated otherwise.

The support material may have a pore volume of from 0.1 cc/g to 1 cc/g, or from 0.2 cc/g to 0.95 cc/g or from 0.25 cc/g to 0.9 cc/g. In addition, the support material may have an average particle size of from 0.1μ to 20μ, or from 0.5μ to 18μ or from 1μ to 15μ when utilized as in powder form. However, it is contemplated that the support material may be converted into particles having varying shapes and particle sizes by pelletization, tableting, extrusion or other known processes.

In one or more embodiments, the support material is a commercially available support material, such as commercially available alumina powders including, but not limited to, PURAL® Alumina and CATAPAL® Alumina, which are high purity bohemite aluminas sold by Sasol Inc.

The metal component may include a Group VIII transition metal. As used herein, the term “Group VIII transition metal” includes oxides and alloys of Group VIII transition metals. The Group VIII transition metal may include nickel, platinum, palladium, rhodium, iridium, gold, osmium, ruthenium or combinations thereof. In one or more embodiments, the Group VIII transition metal includes nickel. In one specific embodiment, the Group VIII transition metal includes nickel salts, such as nickel nitrate, nickel carbonate, nickel acetate, nickel oxalate, nickel citrate or combinations thereof.

The catalyst may include from about 0.1 wt. % to 60 wt. %, from 0.2 wt. % to 50 wt. % or from 0.5 wt. % to 40 wt. % metal component relative to the total weight of catalyst.

One or more embodiments include contacting the support material or catalyst with a modifier to form a modified support or modified catalyst (which will be referred collectively herein as modified support). For example, the modifier may include a modifier exhibiting selectivity to hydrogen.

In one or more embodiments, the modifier includes an alkaline earth element, such as magnesium or calcium. In one or more specific embodiments, the modifier is a magnesium containing compound. For example, the magnesium containing compound may include magnesium oxide or be supplied in the form of a magnesium salt (e.g., magnesium hydroxide, magnesium nitrate, magnesium acetate or magnesium carbonate).

The catalyst may include from 0.1 wt. % to 15 wt. %, or from 0.5 wt. % to 14 wt. % or from 1 wt. % to 12 wt. % modifier relative to the total weight of support material.

The modified support may have a surface area of from 20 m²/g to 400 m²/g, or from 25 m²/g to 300 m²/g or from 25 m²/g to 200 m²/g.

In one or more embodiments, the catalyst further includes one or more additives. In one or more embodiments, the additive is a promoter. The promoter may be selected from rare earth elements, such as lanthanum. The rare earth elements may include solutions, salts (e.g., nitrates, acetates or carbonates), oxides and combinations thereof.

The catalyst may include from 0.1 wt. % to 15 wt. %, from 0.5 wt. % to 15 wt. % or from 1 wt. % to 15 wt. % additive relative to the total weight of catalyst.

In one or more embodiments, the catalyst includes a greater amount of additive than modifier. For example, the catalyst may include at least 0.1 wt. %, or at least 0.15 wt. % or at least 0.5 wt. % more additive than modifier. In another embodiment, the catalyst includes substantially equivalent amounts of additive and modifier.

The reformer is operated under high pressure reforming conditions. In one or more embodiments, the reformer may be operated at a reformer operation pressure of less than 300 psig, from 100 psig to 600 psig, or from 200 psig to 400 psig, or from 200 psig to 240 psig, or from 150 psig to 275 psig, or from 150 psig to 250 psig or from 150 psig to 225 psig.

The reformer may be operated at temperatures of less than 900° C., or less than 875° C., or less than 850° C., or from 500° C. to 825° C. or from 600° C. to 825° C. In some instances, the embodiments of the invention are capable of operation at lower reformer temperatures.

Lower reformer temperatures (i.e., temperatures of less than 900° C.) can result in a lower utilities demand, lower construction material cost (due at least in part to a reduction in corrosion and stress on process equipment), more favorable water gas shift equilibrium and increased hydrogen levels in the reformate, for example.

The reformer may be operated under steam reforming conditions which are defined by adding substantially no oxygen to the feeds to the reformer. Different reforming processes such as autothermal reforming and catalytic partial oxidation require the addition of oxygen to combust components in the reformer to provide heat. The process of steam reforming excludes the addition of oxygen or at least significant quantities of oxygen. Small amounts of oxygen may be introduced to a steam reforming process, but it is not preferred. Steam reforming conditions can be defined as those in which the amount of oxygen (or air) that is added is less than 2% of the total reformer feed, preferably less than 1% of the total reformer feed and more preferably less than 0.5% of the total reformer feed stream. It is most preferred for no oxygen to be added or at least substantially no oxygen to be added.

In another embodiment, the reformer may be operated under partial oxidation conditions. Partial oxidation systems are based on incomplete combustion. Decomposition of the feed stream to primarily hydrogen and carbon monoxide (CO) occurs through thermal cracking reactions at high temperatures. Autothermal (mixed) reforming is a variation on catalytic partial oxidation in which increased quantities of steam are used to promote steam reforming and reduce coke formation. Both partial oxidation systems and autothermal reforming require oxygen.

Additional hydrogen can be produced via a water gas shift reaction that converts carbon monoxide (CO) into carbon dioxide (CO₂). Therefore, the reformate may optionally be passed to a water-gas shift reaction zone(s) where the process stream (e.g., the reformate) is further enriched in hydrogen by reaction of carbon monoxide present in the process stream with steam in a water-gas shift reaction to form a water-gas shift product stream having a greater hydrogen concentration than the hydrogen concentration of the reformate.

The water-gas shift reaction zone may include any reactor (or combination of reactors) capable of converting carbon monoxide to hydrogen. For example, the reactor may include a fixed-bed catalytic reactor. The water-gas shift reactor includes a water-gas shift catalyst. The water-gas shift catalyst may include any catalyst capable of promoting the water-gas shift reaction. For example, the water-gas shift catalyst may include alumina, chromia, iron, copper, zinc, the oxides thereof or combinations thereof. In one or more embodiments, the water-gas shift catalyst includes commercially available catalysts from BASF Corp, Sud Chemie or Haldor Topsoe.

The water-gas shift reaction generally goes to equilibrium at the temperatures required to drive the reforming reaction (therefore, hindering the production of hydrogen from carbon monoxide). Therefore, the water-gas shift reactor typically operates at an operation temperature that is lower than reformer operation temperature (e.g., at least 50° C. less, or at least 75° C. less or at least 100° C. less). For example, the water-gas shift reaction may occur at a temperature of from about 200° C. to about 500° C., or from 250° C. to about 475° C. or from 275° C. to about 450° C.

In one or more embodiments, the water-gas shift reaction is operated in a plurality of stages. For example, the plurality of stages may include a first stage and a second stage.

Generally, the first stage is operated at a temperature that is higher than that of the second stage (e.g., the first stage is high temperature shift and the second stage is a low temperature shift). In one or more embodiments, the first stage may operate at a temperature of from 350° C. to 500° C., or from 360° C. to 480° C. or from 375° C. to 450° C. The second stage may operate at a temperature of from 200° C. to 325° C., or from 215° C. to 315° C. or from 225° C. to 300° C. It is contemplated that the plurality of stages may occur in a single reaction vessel or in a plurality of reaction vessels.

The hydrogen may be used directly in a variety of applications, such as petrochemical processes, without further reaction or purification. The hydrogen produced is already at high pressure since the entire system is operated at high pressure. For purposes of this application, the high pressure may be defined as a pressure of less than 600 psig, from 100 psig to 400 psig, or from 200 psig to 400 psig, or from 200 psig to 275 psig, or from 150 psig to 300 psig, or from 150 psig to 250 psig or from 150 psig to 225 psig. In other conventional ethanol reforming processes, the hydrogen produced in a low pressure or atmospheric reforming step must be pressurized in a compressor which is a capital expense as well as results in a large operating and maintenance expense.

The reforming process may further include purification of the hydrogen. The purification process may include separation, such as separation of the hydrogen from the reformate or water-gas shift product stream, to form a purified hydrogen stream. For example, the separation process may include adsorption, such as pressure swing adsorption processes which form a purified hydrogen stream and a tail gas. Alternatively, the separation process may include membrane separation to form a purified hydrogen stream and a carbon dioxide rich stream. One or more embodiments include both adsorption and membrane separation.

The purified hydrogen stream may include at least 95 vol. %, or at least 98 vol. % or at least 99 vol. % hydrogen relative to the weight of the purified hydrogen stream, for example.

The system is preferably heat integrated as much as possible. The reformer feed stream is heated prior to introduction into the reformer. In addition, product streams (e.g., the reformate, the water-gas shift product stream or combinations thereof) may require chilling (e.g., a reduction of the temperature) prior to subsequent processes. Generally, reforming processes have included heat exchange of each process stream (e.g., reformer feed stream and product streams) with an externally supplied heat exchange fluid (e.g., within a heat exchanger) to control the temperature thereof (either heating or chilling as required), thereby adding size and weight to the overall reforming system.

However, in one or more specific embodiments of the invention, the process includes contacting one or more of the process streams with another process stream (rather than an external heat exchange fluid) to exchange heat therebetween. For example, one or more embodiments include contacting the reformate with the reformer feed stream prior to introduction into the reformer to transfer heat from the reformate to the reformer feed stream (thereby heating the reformer feed stream and cooling the reformate). The process may include contacting the water-gas shift product stream with the reformer feed stream prior to introduction into the reformer. It is contemplated that while at least a portion of the heat exchange requirements of the process may be replaced by heat exchange contact between feed streams and product streams within the process, a portion of the required heat exchange may be accomplished by contact with an externally supplied heat exchange fluid.

In another embodiment, the heat required may be provided by combustion of byproducts and/or solids from the biomass fermentation process described above.

One or more specific embodiments include sequentially heating the reformer feed stream by sequential contact with increasingly warmer product streams. For example, one or more specific embodiments include heat exchange contact with the water-gas shift product stream, such as the first stage water-gas shift product stream, the second water-gas shift product stream or combinations thereof, followed by heat exchange contact with the reformate as described previously.

The heat exchange contact may occur by passing the reformer feed stream through a heat exchanger counter-current to the product stream. In one or more embodiments, the feed stream passes counter-current to the product stream.

In addition to heating the reformer feed stream, the heat exchange contact reduces the temperature of the reformate without the need for introduction of an outside heat or cooling source. However, when external heat exchange fluids are utilized within a portion of the process, it is contemplated that the heat exchangers utilizing the external heat exchange fluids will be smaller and require less power than those of conventional processes employing solely externally supplied heat exchange fluids due to the reduced temperature difference between the externally supplied heat exchange fluid and the process stream requiring heat exchange.

As discussed above, the reformer is generally heated by an external heat source. However, one or more embodiments of the invention utilize a process stream as a reformer heat source. For example, one or more specific embodiments utilize tail gas to at least partially heat the reformer. For example, the tail gas may be utilized as a fuel to the combustion furnace that generates hot flue gases that heat the reformer. It is further contemplated that the tail gas may be further heated by heat exchange contact with a heat exchange fluid prior to direct heating of the reformer via the combustion furnace. Alternatively, one or more specific embodiments utilize the byproducts from the fermentation process as a fuel to the combustion furnace that produces hot flue gases to heat the reformer.

Further, as discussed above, steam reforming processes include introducing steam into the reformer. Generally, the steam is provided to the reforming process from an external source. However, in this invention, steam is already present and its content adjusted by the distillation or flashing conditions to suit the required concentration by the reformer. One or more embodiments of the invention include utilizing condensate produced from the one or more heat exchangers as the steam for the reformer. While the condensate is often in vapor form, it is contemplated that the condensate may be liquid when supplied to the reformer, thereby requiring vaporization prior to introduction into the reformer. Utilizing the condensate for at least a portion of the required steam minimizes the need for an external water supply, thereby reducing the overall process water consumption.

In one or more embodiments, the CO₂ produced during the fermentation process and/or during the formation of hydrogen may be captured and utilized for high pressure injection applications, such as oil recovery. Such applications enhance the oil and gas recovery process, while at the same time minimizing the carbon impact on the environment (the carbon dioxide is turned into a non-volatile component within the earth).

It is further contemplated that the CO₂ formed by the fermentation step can be combined with the CO₂ recovered from the effluent of the water gas shift reactors, and be compressed and sequestrated, thus preventing the release of CO₂ into the atmosphere.

### EXAMPLES

### Example 1

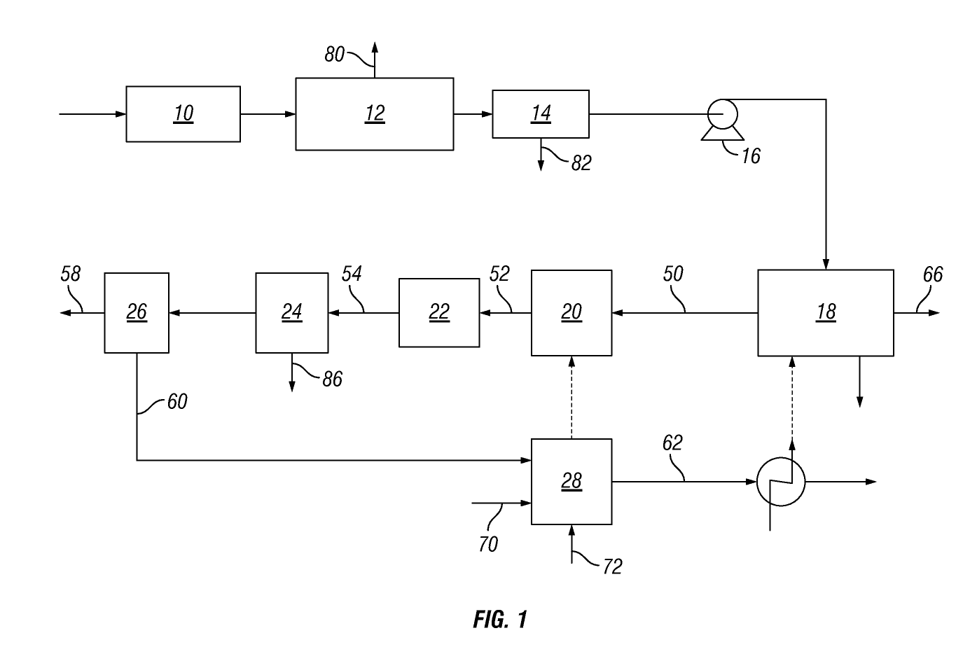

This example demonstrates the simulated results of an embodiment of the invention. The details provided below and in Table 1 show the results of an ASPEN Plus® simulation where the ethanol produced by a fermentation process is passed through a simple distillation step and then into a reformer at high pressure operating conditions. The example is described with respect to FIG. 1. FIG. 1 depicts the main steps of the process, but it is not intended to be a complete diagram of all equipment, valves, and piping that would be necessary to the process.

In FIG. 1, block 10 represents the bio-mass pre-processing step. The details of this step will depend on the type of biomass fed to the process. Block 12 represents the saccharification and fermentation of the pre-processed bio-mass. These may be carried out in any number of steps and according to any process known to one of ordinary skill in the art. Carbon dioxide is removed through line 80. In block 14, solids are separated via line 82 and a mixture comprising ethanol and water is passed to pump 16 via line 46. The mixture is pumped to a column 18 where a portion of the water is separated and passed through line 66. The column 18 has been described in this application, but it is preferably a simple distillation column. The remaining ethanol/water vapor mixture passes via line 50 to reformer 20 where the high pressure reforming occurs. The reformer products are passed via line 52 to a water gas shift reaction zone 22. The water gas shift reaction zone may comprise multiple reactors operated at different temperatures. The reaction zone 22 preferably comprises at least one high temperature water gas shift reactor and one low temperature water gas shift reactor. The water gas shift products are passed via line 54 to a carbon dioxide removal step 24. The carbon dioxide separated in line 86 from the process can be sequestered as described above. The products from that separation are then passed to a PSA (pressure swing adsorption) system 26, where the hydrogen is removed from the process via hydrogen product line 58. The tail gas is passed via line 60 to furnace 28. The tail gas, along with air fed via line 70 and optionally natural gas fed via line 72 is combusted in the furnace to provide heat to the reformer. The hot flue gas in line 62 may be used to provide heat to the column 18. Table 1 provides process information calculated during an ASPEN Plus® simulation of an embodiment as described in this example.

TABLE 1

| | Line # | | | | | | | | | | | |
|---|---|---|---|---|---|---|---|---|---|---|---|---|
| Mass Flow kg/hr | 46 | 48 | 50 | 66 | 52 | 54 | 56 | 58 | 86 | 60 | 72 | 80 |
| WATER | 407175 | 407175 | 87209 | 319966 | 61820 | 48248 | 87 | 0 | 0 | 127 | 0 | 0 |
| ETHANOL | 37825 | 37825 | 37614 | 211 | 0 | 0 | 0 | 0 | 0 | 0 | 0 | 0 |
| CO | 0 | 0 | 0 | 0 | 21525 | 422 | 422 | 0 | 0 | 413 | 0 | 0 |
| CO₂ | 0 | 0 | 0 | 0 | 32067 | 65224 | 6522 | 0 | 58701 | 6218 | 0 | 36312 |
| H₂ | 0 | 0 | 0 | 0 | 7231 | 8750 | 8750 | 7525 | 0 | 1225 | 0 | 0 |
| CH₄ | 0 | 0 | 0 | 0 | 2179 | 2179 | 2179 | 0 | 0 | 2162 | 3748 | 0 |
| Total Flow kg/hr | 445000 | 445000 | 124823 | 320177 | 124822 | 124822 | 17960 | 7525 | 58701 | 10144 | 3748 | 36312 |
| Temperature K | 298 | 298 | 471 | 479 | 1098 | 491 | 297 | 289 | 298 | 278 | 298 | 298 |
| Pressure atm | 1.0 | 18.0 | 17.1 | 17.5 | 16.8 | 16.1 | 15.9 | 15.1 | 3.0 | 1.4 | 3.4 | 1.0 |

### Comparative Example 1

This example demonstrates the simulated results of a conventional process. The details provided below and in Table 2 show the results of an ASPEN Plus® simulation where high-purity (fuel/chemical grade) ethanol is mixed with water and then directly fed to the reforming process.

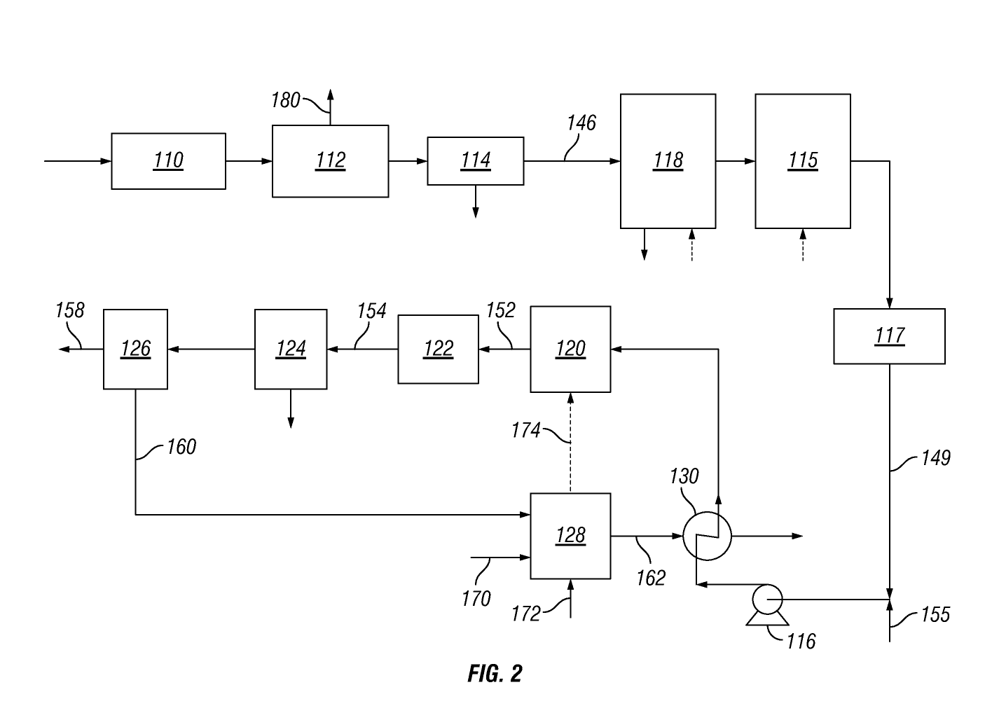

The example is described with respect to FIG. 2. FIG. 2 depicts a conventional ethanol steam reforming process. Typically, fuel/chemical grade ethanol is prepared by steps 110 to 117. Blocks 110 to 114 are similar to blocks 10 to 14 in FIG. 1 and correspond to the bio-mass preprocessing 110; saccharification and fermentation 112; and solids removal 114. Carbon dioxide is removed through line 180. The mixture containing ethanol and water produced by steps 110 to 114 is at ambient pressures and is passed via line 146 to distillation column 118. Column 118 is not a simple column as described in Example 1. The column typically has 30 to 45 stages operating at low pressures. The product from the distillation column is passed to rectification column 115 and then to a molecular sieve separation step 117. The rectification column typically has 30-45 stages operating at low pressures. Due to the high purity requirement and the formation of an azeotrope between water and ethanol, the production of chemical/fuel grade ethanol requires extensive distillation, rectification with reflux and further steps to remove the water. The processes related to blocks 110 to 117 are operated separately from the remainder of the process and the high purity ethanol in line 149 is typically transported to a location where it can be further processed and fed to a reformer.

The high purity ethanol produced is passed to pump 116 after mixing it with water fed in via line 155. The water/ethanol mixture is heated in heat exchanger 130 and passed to the reformer 120. The reformer products are passed via line 152 to a water gas shift reaction zone 122. The water gas shift reaction zone may comprise multiple reactors operated at different temperatures. The reaction zone 122 preferably comprises at least one high temperature water gas shift reactor and one low temperature water gas shift reactor. The water gas shift products are passed via line 154 to a carbon dioxide removal step 124. The carbon dioxide separated from the process can be sequestered as described above. The products from that separation are then passed to a PSA (pressure swing adsorption) system 126, where the hydrogen is removed from the process via hydrogen product line 158. The tail gas is passed via line 160 to furnace 128. The tail gas, along with air fed via line 170 and optionally natural gas fed via line 172 is combusted in the furnace to provide heat to the reformer. The hot flue gas in line 162 is used to preheat the ethanol/water mixture. Table 2 provides process information calculated during an ASPEN Plus® simulation of an embodiment as described in this example.

TABLE 2

| Mass Flow | Line # | | | | | | | | | | | | |
|---|---|---|---|---|---|---|---|---|---|---|---|---|---|
| kg/hr | 146 | 148 | 149 | 153 | 150 | 152 | 154 | 156 | 158 | 160 | 172 | 180 | 186 |
| WATER | 404902 | 5129 | 0 | 88253 | 88253 | 62747 | 49228 | 89 | 0 | 126 | 0 | 0 | 0 |
| ETHANOL | 37614 | 37614 | 37614 | 37614 | 37614 | 0 | 0 | 0 | 0 | 0 | 0 | 0 | 0 |
| CO | 0 | 0 | 0 | 0 | 0 | 21416 | 396 | 396 | 0 | 387 | 0 | 0 | 0 |
| CO₂ | 0 | 0 | 0 | 0 | 0 | 32297 | 65323 | 6532 | 0 | 6219 | 0 | 36109 | 58791 |
| H₂ | 0 | 0 | 0 | 0 | 0 | 7250 | 8762 | 8762 | 7536 | 1227 | 0 | 0 | 0 |
| CH₄ | 0 | 0 | 0 | 0 | 0 | 2158 | 2158 | 2158 | 0 | 2140 | 2620 | 0 | 0 |
| Total Flow | 442516 | 42743 | 37614 | 125867 | 125867 | 125867 | 125867 | 17937 | 7536 | 10099 | 2620 | 36109 | 58791 |
| kg/hr | | | | | | | | | | | | | |
| Temperature | 298 | 298 | 298 | 302 | 953 | 1098 | 488 | 297 | 289 | 278 | 298 | 298 | 298 |
| K | | | | | | | | | | | | | |
| Pressure | 1.0 | 1.0 | 1.0 | 17.7 | 17.3 | 16.9 | 16.3 | 16.1 | 15.2 | 1.4 | 3.4 | 1.0 | 3.0 |
| atm | | | | | | | | | | | | | |

### Comparative Example 2

This example demonstrates the simulated results of a conventional process where the reformer is operated at low pressure. The details provided below and in Table 3 show the results of an ASPEN Plus® simulation where the reforming was carried out at low pressure and the hydrogen produced was fed through a compressor to produce high pressure hydrogen.

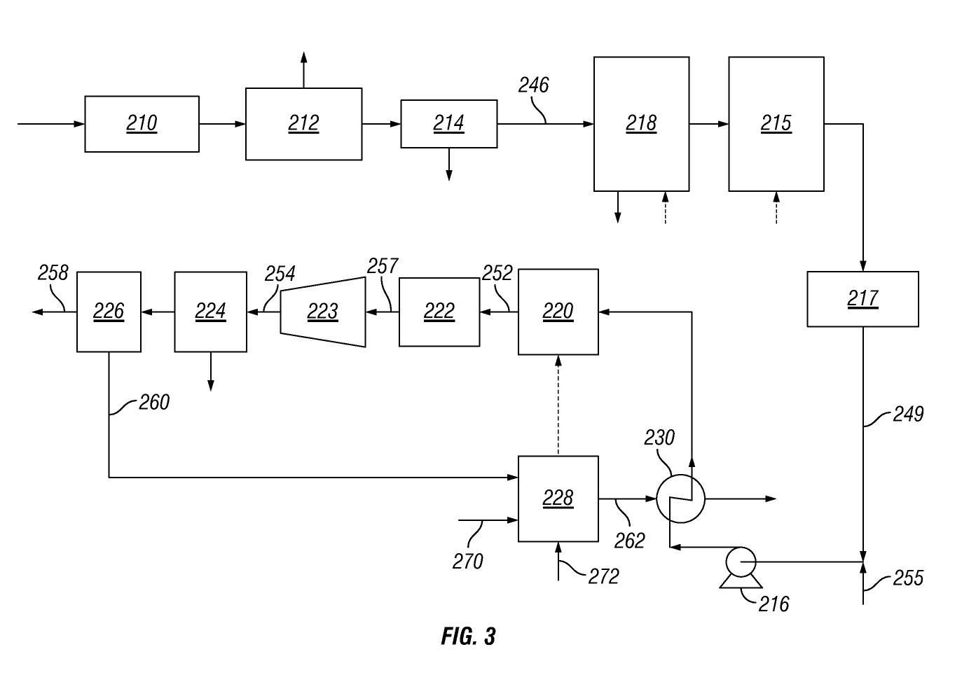

The example is described with respect to FIG. 3. FIG. 3 depicts a conventional ethanol steam reforming process with a low pressure reformer. Typically, fuel/chemical grade ethanol is prepared by steps 210 to 217. Blocks 210 to 214 are similar to blocks 10 to 14 in FIG. 1 and correspond to the bio-mass preprocessing 210; saccharification and fermentation 212; and solids removal 214. The mixture containing ethanol and water produced by steps 210 to 214 is at ambient pressures and is passed via line 246 to distillation column 218. Column 218 is not a simple column as described in Example 1. The column typically has 30 to 45 stages operating at low pressures. The product from the distillation column is passed to rectification column 215 and then to a molecular sieve separation step 217. The rectification column typically has 30-45 stages operating at low pressures. Due to the high purity requirement and the formation of an azeotrope between water and ethanol, the production of chemical/fuel grade ethanol requires extensive distillation, rectification with reflux and further steps to remove the water. The processes related to blocks 210 to 217 are operated separately from the remainder of the process and the high purity ethanol in line 249 is typically transported to a location where it can be further processed and fed to a reformer.

The high purity ethanol produced is passed to pump 116 after mixing it with water fed in via line 255. The water/ethanol mixture is heated in heat exchanger 230 and passed to the reformer 220. The reformer products are passed via line 252 to a water gas shift reaction zone 222. The water gas shift reaction zone may comprise multiple reactors operated at different temperatures. The reaction zone 222 preferably comprises at least one high temperature water gas shift reactor and one low temperature water gas shift reactor. The water gas shift products are passed via line 257 to a multi-stage compressor 223 and the compressor outlet stream 254 is directed to a carbon dioxide removal step 224. The carbon dioxide separated from the process can be sequestered as described above. The products from that separation are then passed to a PSA (pressure swing adsorption) system 226, where the hydrogen is removed from the process via hydrogen product line 258. The tail gas is passed via line 260 to furnace 228. The tail gas, along with air fed via line 270 and optionally natural gas fed via line 272 is combusted in the furnace to provide heat to the reformer. The hot flue gas in line 262 is used to preheat the ethanol/water mixture. Table 3 provides process information calculated during an ASPEN Plus® simulation of an embodiment as described in this example.

TABLE 3

| Mass Flow | Line # | | | | | | | | | | | |
|---|---|---|---|---|---|---|---|---|---|---|---|---|
| kg/hr | 246 | 248 | 249 | 253 | 250 | 252 | 257 | 254 | 258 | 260 | 286 | 280 |
| WATER | 404906 | 5129 | 0 | 88254 | 88254 | 60239 | 44632 | 537 | 0 | 537 | 0 | 0 |
| ETHANOL | 37614 | 37614 | 37614 | 37614 | 37614 | 0 | 0 | 0 | 0 | 0 | 0 | 0 |
| CO | 0 | 0 | 0 | 0 | 0 | 24927 | 661 | 660 | 1 | 659 | 0 | 0 |
| CO₂ | 0 | 0 | 0 | 0 | 0 | 32603 | 70730 | 70574 | 0 | 7057 | 63516 | 36110 |
| H₂ | 0 | 0 | 0 | 0 | 0 | 8064 | 9810 | 9810 | 8731 | 1079 | 0 | 0 |
| CH₄ | 0 | 0 | 0 | 0 | 0 | 36 | 36 | 36 | 0 | 36 | 0 | 0 |
| Total Flow | 442520 | 42743 | 37614 | 125868 | 125868 | 125868 | 125868 | 81616 | 8731 | 72885 | 0 | 0 |
| kg/hr | | | | | | | | | | | | |
| Temperature | 298 | 298 | 298 | 301 | 964 | 1098 | 501 | 297 | 297 | 279 | 298 | 298 |
| K | | | | | | | | | | | | |
| Pressure | 1 | 1.0 | 1.0 | 2.5 | 2.1 | 1.8 | 1.1 | 20.3 | 19.6 | 1.4 | 3.0 | 1.0 |
| atm | | | | | | | | | | | | |

What is claimed is:

1. A process for producing hydrogen comprising:
a. producing an aqueous feed stream comprising 5% to 15% wt. ethanol by a biomass fermentation process;
b. separating at least a portion of the water from the aqueous feed stream so that the content of ethanol in a resulting reformer feed stream is in the range of from 15% to 35% wt; and
c. contacting the reformer feed stream with a catalyst in a reformer under high pressure reforming conditions to produce a reformer product stream comprising hydrogen wherein the pressure in the reformer is in a range of from 100 psi to 600 psi.

2. A process as claimed in claim 1 wherein the concentration of ethanol in the reformer feed stream is in the range of from 20% to 35%.

3. A process as claimed in claim 1 wherein the concentration of ethanol in the reformer feed stream is in the range of from 25% to 30%.

4. A process as claimed in claim 1 wherein the pressure in the reformer is in a range of from 200 psi to 300 psi.

5. A process as claimed in claim 1 further comprising a step of pumping the feed stream to a pressure in a range of from 100 psi to 600 psi before the separation of step (b).

6. A process as claimed in claim 1 further comprising burning a fuel in a furnace that provides heat to the reformer wherein flue gas from the furnace and/or hot reformer product stream provides heat to the separation of step (b).

7. A process as claimed in claim 6 wherein a biomass waste produced in step (a) is used as a fuel to the furnace.

8. A process as claimed in claim 6 wherein a biogas is used as a fuel to the furnace.

9. A process as claimed in claim 1 further comprising passing the reformer product stream through one or more water gas shift reaction zones to produce additional hydrogen and carbon dioxide.

10. A process as claimed in claim 9 wherein the carbon dioxide produced by the water gas shift reaction is separated from the process stream and then combined with carbon dioxide produced in step (a).

11. A process as claimed in claim 1 wherein the carbon dioxide is not released to the atmosphere.

12. A process as claimed in claim 1 wherein the no oxygen is added to the reformer feed stream.

13. A process as claimed in claim 1 wherein a hydrocarbon is fed to step (c) with the reformer feed stream.

14. A process as claimed in claim 13 wherein the hydrocarbon is a compound having from 1 to 8 carbon atoms.

15. A process as claimed in claim 13 wherein the hydrocarbon is selected from the group consisting of methane, ethane, propane and butane.

16. A process as claimed in claim 13 wherein the hydrocarbon comprises biogas.
